(19) United States
(12) Patent Application Publication
(10) Pub. No.: US 2007/0154862 A1
(43) Pub. Date: Jul. 5, 2007

(54) Assistant for implant stent

(76) Inventor: Jong-Pil Kim, Gumi (KR)

Correspondence Address: SHERR & NOURSE, PLLC, 620 HERNDON PARKWAY, SUITE 200, HERNDON, VA, 20170, US

(21) Appl. No.: 10/596,174

(22) PCT Filed: Dec. 2, 2004
(86) PCT No.: PCT/KR04/03158

§ 371 Date: Jun. 2, 2006

(30) Foreign Application Priority Data
Dec. 3, 2003 (KR) 10-2003-0087152
Aug. 21, 2004 (KR) 10-2004-0066188
Nov. 29, 2004 (KR) 10-2004-0098628

(51) Int. Cl. A61C 19/04

(52) U.S. Cl. 433/72

(57) ABSTRACT

The present invention relates to an assistant for implant stent. The assistant for implant stent of the present invention comprises a body with a predetermined length and a drill insertion hole bored through the body from a top surface to a bottom surface thereof. The body comprises a support portion with a predetermined thickness and a sectional area greater than that of the body. The support portion is formed on the top surface of the body.

### TECHNICAL FIELD

The present invention relates to an assistant for implant stent, and more particularly, to an assistant for implant stent for allowing an implant to be more accurately and safely placed in an alveolar bone of a patient.

### BACKGROUND ART

An implant is a kind of dental prosthesis used to substitute for a decayed or lost tooth. Since the implant can be used for the surgical operation of a specific tooth without any damage to the adjacent teeth and has a relatively long life span, an implant technique is one of medical techniques that have been recently spotlighted.

After an alveolar bone of a patient is drilled using a drill, such an implant is placed in the alveolar bone. Therefore, it is very important to drill the alveolar bone of the patient.

FIG. 1 is a perspective view illustrating a conventional stent used for the placement of an implant and illustrating a state where a tooth is drilled using the stent. The stent S is manufactured to have the same shape as a tooth T before the implant is placed, such that it can be used to find out an accurate placement position. The stent is made of resin (acryl) or the like and is fitted and fixed between the adjacent teeth.

A process of placing an implant using the aforementioned stent S will be explained as follows.

First, a female mold of a patient is obtained using a rubber impression material and plaster is then poured into the obtained female mold so as to manufacture a plaster cast having the exactly same shape as maxillary and mandibular bones of the patient. Then, the plaster cast is coupled to an artificial articulator such that the mutual relationship between a jaw joint and the maxillary and mandibular teeth T having the almost the same as a state of the patient can be reconstructed out of an oral cavity. Thereafter, a dental cast which will be coupled to a region where the tooth T was lost is manufactured and then used as a stent S. A central portion of the artificial dental cast formed in the stent S becomes a position where the implant is placed, and the stent S is finished after a hole H through which a drill can be inserted has been formed. In general, the stent S is manufactured such that it can be inserted between the adjacent teeth T, and then inserted and fixed between the teeth T. The number and position of the implants to be placed are determined by synthetically considering the oral condition and X-ray results of the patient.

After the stent S has been completely manufactured, a gingiva of the patient is incised and the stent S is then inserted between the remaining teeth T. Further, a drilling position is marked on a proper region on an upper end of the alveolar bone B of the patient with reference to the position of the hole H drilled through the stent S, and a position where the implant will be placed is prepared by inserting a drill D into the hole H of the stent S from above and then drilling the marked position.

At this time, in a case where the uppermost center of the alveolar bone B is positioned below the hole H, the drill D may be vertically positioned at the center of the hole H of the stent S and the alveolar bone B may be then drilled. However, in a case where the uppermost portion of the alveolar bone B is shifted inward or outward from the bottom of the hole H, it is difficult to move the drill D to a correct position and perform the drilling operation if the diameter of the hole H is small. Therefore, the hole H should be formed to have a larger diameter. In the meantime, an error in drilling angle can be reduced since vibration in the drill D can be proportionally reduced as the diameter of the hole H becomes smaller. However, in a case where the diameter of the hole H is too small, there is a problem in that the drilling angle cannot be changed since the drill D is caught in the wall of the hole H. On the other hand, if the diameter of the hole H is large, the drilling angle can be easily changed, but vibration is produced in the drill D and an error can be generated when an operator determines the drilling angle.

In addition, when the alveolar bone B is drilled, the scale of the drill D is confirmed on a surface of the alveolar bone B. In such a case, since the drilled region on the alveolar bone B is positioned at a deep place in the oral cavity, a range of vision of the operator is narrow and the drilled portion cannot be easily accessed. Further, if the alveolar bone B is covered with the bleeding generated during the operation, it is not easy for the operator to confirm the scale of the drill.

Further, in a case where the drilling was either made unduly or not made at a depth desired by the operator since the scale of the drill cannot be easily confirmed as described above, there is a problem in that any complication is induced or the drilling operation should be conducted again.

Moreover, since a drilling method using the conventional stent S is highly likely to cause an actually drilled position to be shifted from the correct position desired by the operator as described above, additional cumbersome procedures for performing the X-ray imaging to confirm the direction in which the alveolar bone B is drilled or confirming whether the surrounding important structures were damaged or are likely to be damaged may be frequently performed even during the operation. As a result, the operation time is extended, or the operator or patient is further harder to operate or endure the operation.

### DISCLOSURE

Technical Problem

Accordingly, the present invention is conceived to solve the problems described above. An object of the present invention is to provide an assistant for implant stent which is mounted to the stent such that a drilling operation can be more stably, accurately and rapidly conducted when a hole for used in implant placement is drilled.

Further, another object of the present invention is to provide an assistant for implant stent capable of accurately and easily measuring a depth of a hole.

Technical Solution

According to a first aspect of the present invention for achieving the aforementioned objects, there is provided an assistant for implant stent for placing an implant in an alveolar bone of a patient. The assistant for implant stent comprises a body with a predetermined length and a drill insertion hole bored through the body from a top surface to a bottom surface thereof, wherein the body includes a support portion with a predetermined thickness and a sectional area greater than that of the body, said the support portion being formed on the top surface of the body.

According to a second aspect of the present invention for achieving the above objects, there is provided an assistant for implant stent for placing an implant in an alveolar bone of a patient. The assistant for implant stent comprises a body with a predetermined length and a drill insertion hole bored through the body from a top surface to a bottom surface thereof, wherein the body includes a support portion with a predetermined thickness, said support portion being formed on the bottom surface of the body and protruding in opposite directions by a predetermined length.

According to a third aspect of the present invention for achieving the above objects, there is provided an assistant for implant stent for placing an implant in an alveolar bone of a patient. The assistant for implant stent comprises a body with a predetermined length and a drill insertion hole bored through the body from a top surface to a bottom surface thereof, wherein the body includes stepped portion recessed on opposite lower edges of the body.

According to a fourth aspect of the present invention for achieving the above objects, there is provided an assistant for implant stent for placing an implant in an alveolar bone of a patient. The assistant for implant stent comprises a body with a predetermined length and a drill insertion hole bored through the body from a top surface to a bottom surface thereof, wherein an opening of the drill insertion hole formed on the top surface of the body is shifted from the center on the top surface of the body by a predetermined distance.

According to the first to third aspects of the present invention, an opening of the drill insertion hole formed on the top surface of the body may be shifted from the center on the top surface of the body by a predetermined distance.

The drill insertion hole may be formed to be inclined at a predetermined angle. Preferably, an extended portion is formed on the bottom surface of the body to protrude downward and the drill insertion hole is bored through the extended portion. More preferably, a horizontal sectional area of the drill insertion hole increases downward of the body. The upper opening of the drill insertion hole may be narrowed downward. Preferably, a horizontal section of the body is rectangular with opposite rounded sides, circular, or rectangular with rounded corners. More preferably, a horizontal section of the upper opening is rectangular with opposite rounded sides, circular, or rectangular with rounded corners.

According to a further aspect of the present invention for achieving the above objects, there is provided an X-ray imaging assistant for determining a direction in which an implant is placed in an alveolar bone of a patient. The X-ray imaging assistant comprises a body with a predetermined length, and a direction indication means formed to protrude from top and bottom surfaces of the body. At this time, a support portion may be further provided on the top surface of the body.

According to a still further aspect of the present invention for achieving the above objects, there is provided an assistant for removing gingiva to place an implant in an alveolar bone of a patient. The assistant comprises a body with a predetermined length, and a cutter taking the shape of a hollow tube and protruding from the bottom surface of the body. At this time, a through-hole that is bored through the body from the top surface to the bottom surface of the body may be further provided. Moreover, a recess into which an upper portion of the alveolar bone is inserted may be formed at a lower portion of the cutter.

According to a still further aspect of the present invention, there is provided a guide for an assistant for guiding an assistant for implant stent for placing an implant in an alveolar bone of a patient. The guide is shaped as a hollow tube in which the assistant for implant stent is inserted and accommodated.

According to a still further aspect of the present invention, there is provided an assistant for stent forming for preparing a mounting position of an assistant for implant stent for placing an implant in an alveolar bone of a patient. The assistant comprises a forming portion with a predetermined length and an insert portion formed to protrude from a bottom surface of the forming portion.

According to a still further aspect of the present invention, there is provided a drilling tool for drilling an alveolar bone of a patient. The drilling tool is configured in such a manner that a connecting member for allowing the tool to be coupled with a power transmission unit is formed on an upper portion of the tool, a drilling member for drilling the alveolar bone is formed at a lower portion of the tool, and a cylindrical guide member with a diameter greater than that of the drilling member is formed between the connecting member and the drilling member.

### BRIEF DESCRIPTION OF DRAWINGS

FIG. 1 is a perspective view illustrating a conventional stent used for the placement of an implant and illustrating a state where a tooth is drilled using the stent.

FIG. 2 is a perspective view illustrating a first embodiment of an assistant for implant stent according to the present invention.

FIG. 3 is a side sectional view illustrating a state where the first embodiment of the assistant for implant stent is mounted to the stent.

FIG. 4 is a side sectional view illustrating a state where a first modified example of the assistant for implant stent according to the first embodiment of the present invention is mounted to the stent.

FIG. 5 is a front sectional view illustrating a state where another example of the assistant for implant stent in which a drill insertion hole has a different inclination direction from that of the first modified example of the first embodiment is mounted to the stent.

FIG. 6 is a side sectional view illustrating a state where a second modified example of the assistant for implant stent according to the first embodiment of the present invention is mounted to the stent.

FIG. 7 is a front sectional view illustrating a state where another example of the assistant for implant stent in which a drill insertion hole has a different shifting direction from that of the second modified example of the first embodiment is mounted to the stent.

FIG. 8 is a perspective view illustrating a second embodiment of an assistant for implant stent according to the present invention.

FIG. 9 is a side sectional view illustrating a state where the second embodiment of the assistant for implant stent is mounted to the stent.

FIG. 10 is a side sectional view illustrating a state where a first modified example of the assistant for implant stent according to the second embodiment of the present invention is mounted to the stent.

FIG. 11 is a front sectional view illustrating a state where another example of the assistant for implant stent in which a drill insertion hole has a different inclination direction from that of the first modified example of the second embodiment is mounted to the stent.

FIG. 12 is a side sectional view illustrating a state where a second modified example of the assistant for implant stent according to the second embodiment of the present invention is mounted to the stent.

FIG. 13 is a front sectional view illustrating a state where another example of the assistant for implant stent in which a drill insertion hole has a different shifting direction from that of the second modified example of the second embodiment is mounted to the stent.

FIG. 14 is a perspective view illustrating a third modified example of the second embodiment of the assistant for implant stent according to the present invention.

FIG. 15 is a perspective view illustrating a third embodiment of an assistant for implant stent according to the present invention.

FIG. 16 is a side sectional view illustrating a state where the third embodiment of the assistant for implant stent is mounted to the stent.

FIG. 17 is a front sectional view illustrating a state where the third embodiment of the assistant for implant stent is mounted to the stent.

FIG. 18 is a side sectional view illustrating a state where a first modified example of the assistant for implant stent according to the third embodiment of the present invention is mounted to the stent.

FIG. 19 is a front sectional view illustrating a state where another example of the assistant for implant stent in which a drill insertion hole has a different inclination direction from that of the first modified example of the third embodiment is mounted to the stent.

FIG. 20 is a side sectional view illustrating a state where a second modified example of the assistant for implant stent according to the third embodiment of the present invention is mounted to the stent.

FIG. 21 is a front sectional view illustrating a state where another example of the assistant for implant stent in which a drill insertion hole has a different shifting direction from that of the second modified example of the third embodiment is mounted to the stent.

FIG. 22 is a perspective view illustrating a fourth embodiment of an assistant for implant stent according to the present invention.

FIG. 23 is a side sectional view illustrating a state where the fourth embodiment of the assistant for implant stent is mounted to the stent.

FIG. 24 is a front sectional view illustrating a state where the fourth embodiment of the assistant for implant stent is mounted to the stent.

FIG. 25 is a side sectional view illustrating a state where a first modified example of the assistant for implant stent according to the fourth embodiment of the present invention is mounted to the stent.

FIG. 26 is a front sectional view illustrating a state where another example of the assistant for implant stent in which a drill insertion hole has a different inclination direction from that of the first modified example of the fourth embodiment is mounted to the stent.

FIG. 27 is a side sectional view illustrating a state where a second modified example of the assistant for implant stent according to the fourth embodiment of the present invention is mounted to the stent.

FIG. 28 is a front sectional view illustrating a state where another example of the assistant for implant stent in which a drill insertion hole has a different shifting direction from that of the second modified example of the fourth embodiment is mounted to the stent.

FIG. 29 is a perspective view illustrating a state where an extended portion is further formed in the first embodiment of the assistant for implant stent according to the present invention.

FIG. 30 is a sectional view of the assistant for implant stent shown in FIG. 29.

FIGS. 31 to 37 are perspective views of the assistant for implant stent with a variety of drill insertion holes formed therein according to the present invention.

FIG. 38 is a perspective view illustrating an X-ray imaging assistant according to the present invention.

FIG. 39 is a front sectional view illustrating a state where the X-ray imaging assistant is mounted to the stent.

FIG. 40 is a perspective view of a gingiva removal assistant according to the present invention.

FIG. 41 is a front sectional view illustrating a state where the gingiva removal assistant is mounted to the stent.

FIG. 42 is a perspective view illustrating another embodiment of a gingiva removal assistant according to the present invention.

FIG. 43 is a side sectional view illustrating a state where the gingiva removal assistant shown in FIG. 42 is mounted to the stent.

FIG. 44 is a perspective view of a stent forming assistant according to the present invention.

FIG. 45 is a perspective view illustrating a state where the stent forming assistant is used.

FIG. 46 is a perspective view of a guide for the assistant according to the present invention.

FIG. 47 is a front sectional view illustrating a state where the guide for the assistant is mounted to the stent.

FIG. 48 is a perspective view of a drilling tool for drilling an alveolar bone according to the present invention.

FIG. 49 is a side sectional view illustrating a state where the drilling tool is inserted in the first embodiment of the assistant for implant stent according to the present invention.

FIG. 50 is a schematic view illustrating a process of drilling the alveolar bone using the assistant for implant stent according to the present invention.

FIG. 51 is a schematic view illustrating another process of drilling the alveolar bone using the assistant for implant stent according to the present invention.

### BEST MODE FOR CARRYING OUT THE INVENTION

Hereinafter, preferred embodiments of the present invention will be explained in detail with reference to the accompanying drawings.

FIG. 2 is a perspective view illustrating a first embodiment of an assistant for implant stent according to the present invention, and FIG. 3 is a side sectional view illustrating a state where the first embodiment of the assistant for implant stent according to the present invention is mounted to the stent.

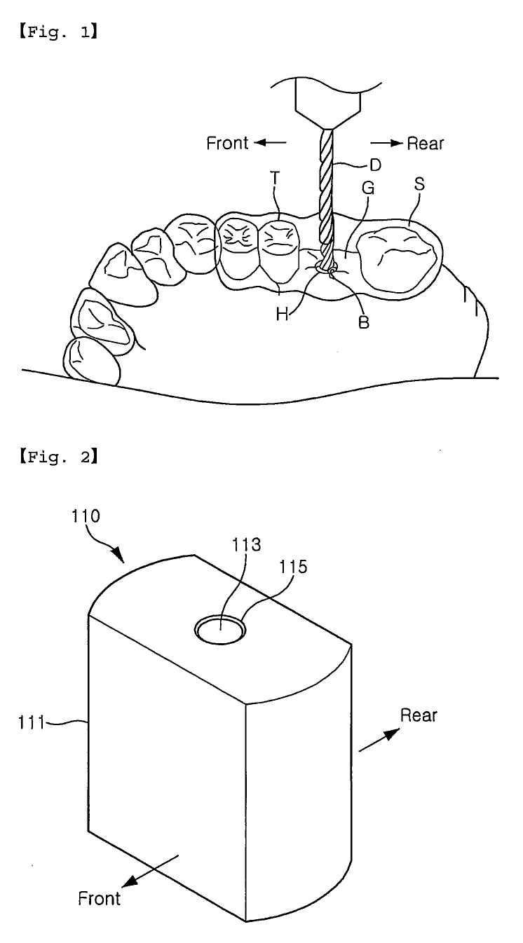

Herein, a term “fore and aft direction” means a direction shown as arrows in FIGS. 1 and 2, and a term “lateral direction” means a direction perpendicular to the fore and aft direction. In the accompanying drawings, therefore, a side sectional view is a sectional view in which an object to be shown is taken along the longitudinal direction and viewed from the lateral direction, and a front sectional view is a sectional view in which an object to be shown is taken along the longitudinal direction and viewed from the fore and aft direction.

As illustrated in a first embodiment of FIGS. 2 and 3, an assistant for implant stent 110 comprises a body 111 of which horizontal section is rectangular with opposite rounded sides (i.e., sides formed in a direction perpendicular to the fore and aft direction shown in the figures) and has a predetermined vertical length, and a drill insertion hole 113 which is bored through the body 111. At this time, the drill insertion hole 113 is formed to pass through the body 111 vertically from the top to the bottom of the body. Further, an upper opening 115 corresponding to an inlet of the drill insertion hole 113 is formed to be narrowed downward such that a drilling means for drilling an alveolar bone B can be easily inserted into the drill insertion hole. Here, although the body 111 of the assistant for implant stent 110 is shaped to be rectangular with the opposite rounded side, the present invention is not limited thereto. The body may be shaped to be circular, elliptical or rectangular with rounded corners.

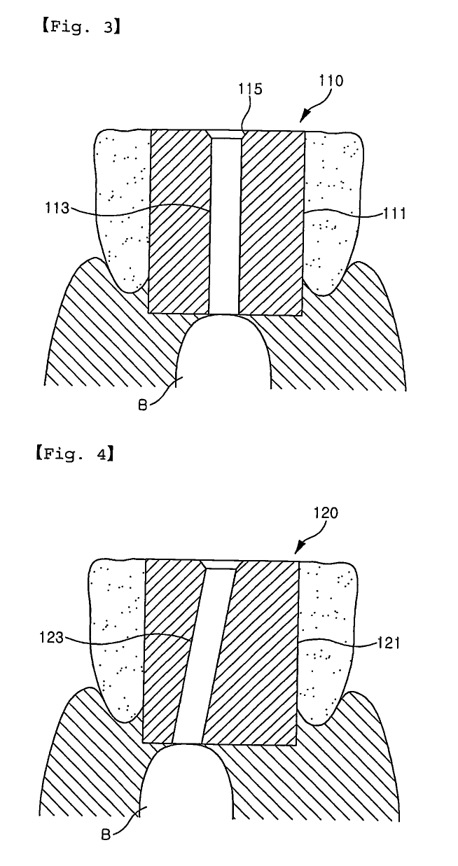

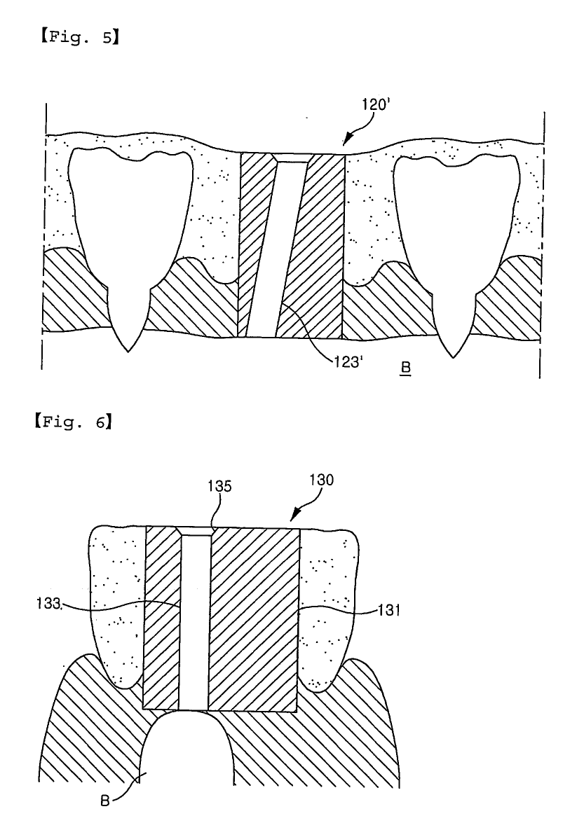

In the meantime, modified examples of this embodiment are more preferable to a patient of which the uppermost end of an alveolar bone B is shifted from the center, rather than the first embodiment of the present invention in which the drill insertion hole 113 is vertically formed at the center of the body 111 as described above. The modified examples of the first embodiment will be described with reference to FIGS. 4 to 7.

FIG. 4 is a side sectional view illustrating a state where a first modified example of the first embodiment of the assistant for implant stent is mounted to the stent, and FIG. 5 is a front sectional view illustrating a state where another example of the assistant for implant stent in which a drill insertion hole has a different inclination direction from that of the first modified example of the first embodiment is mounted to the stent.

As shown in FIG. 4, the first modified example of an assistant for implant stent 120 according to the first embodiment of the present invention comprises a body 121 which takes the same shape as the body of the assistant for implant stent 110, and a drill insertion hole 123 which is inclined at a predetermined angle laterally with respect to a top surface of the body 121.

Here, if the assistant for implant stent 120 in which the drill insertion hole 123 is inclined at the predetermined angle is used, a drilling operation can be conducted at the most suitable position on the alveolar bone B of even the patient of which the uppermost end of the alveolar bone B is shifted from the center. At this time, the drill insertion hole may be inclined not only in the lateral direction but also in the fore and aft direction as shown in FIG. 5. The direction in which the drill insertion hole 123 or 123′ is inclined is not limited to the lateral or fore and aft direction of the assistant for implant stent 120 or 120′ and may be formed in any directions. Further, the drill insertion hole 123 or 123′ may be formed to have a variety of inclination angles.

Since the uppermost end of the alveolar bone B is generally different for every patient, it is preferred that an operator beforehand prepare a plurality of assistants for implant stent of which inclination directions of the drill insertion holes are different from each other.

FIG. 6 is a side sectional view illustrating a state where a second modified example of the first embodiment of the assistant for implant stent is mounted to the stent, and FIG. 7 is a front sectional view illustrating a state where another example of the assistant for implant stent in which a drill insertion hole has a different shifting direction from that of the second modified example of the first embodiment is mounted to the stent.

As shown in FIG. 6, the second modified example of an assistant for implant stent 130 according to the first embodiment of the present invention comprises a body 131 which takes the same shape as the body of the assistant for implant stent 120, and a drill insertion hole 133 which is formed to be vertical with respect to a top surface of the body 131 and includes an upper opening 135 shifted from the center of the top surface.

Here, if the assistant for implant stent 130 in which the drill insertion hole 133 is shifted by a predetermined distance from the center of the top surface of the body 131 is used, a drilling operation can be conducted at the most suitable position on the alveolar bone B of even the patient of which the uppermost end of the alveolar bone B is shifted from the center. At this time, the drill insertion hole may be shifted not only in the lateral direction but also in the fore and aft direction as shown in FIG. 7. The direction in which the drill insertion hole 133 or 133′ is shifted is not limited to the lateral or fore and aft direction of the assistant for implant stent 130 or 130′ and may be formed in any directions. Further, the drill insertion hole 133 or 133′ may be formed to be inclined in various angles as well as to be vertical with respect to the top surface of the body 131 or 131′.

Since the uppermost end of the alveolar bone B is generally different for every patient, it is preferred that an operator beforehand prepare a plurality of assistants for implant stent of which shifting directions of the drill insertion holes are different from each other.

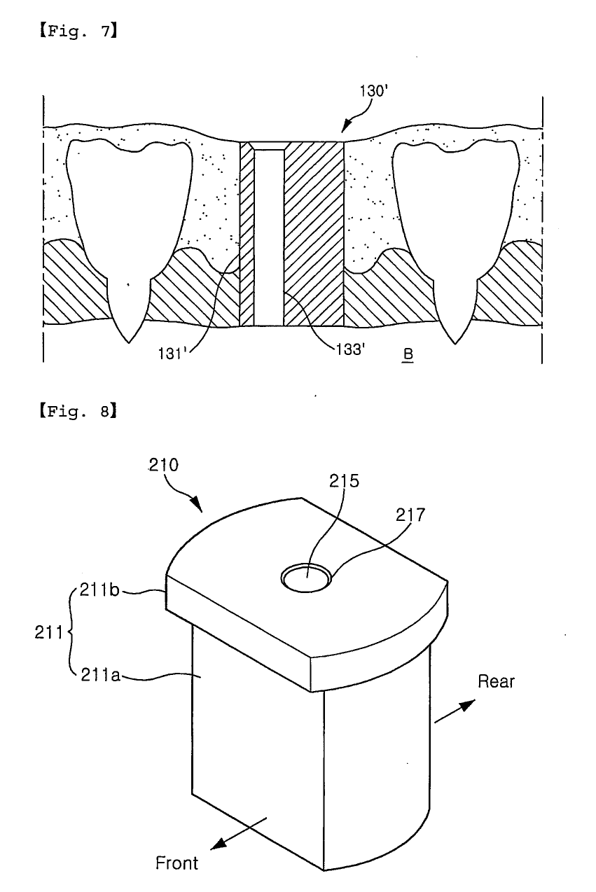

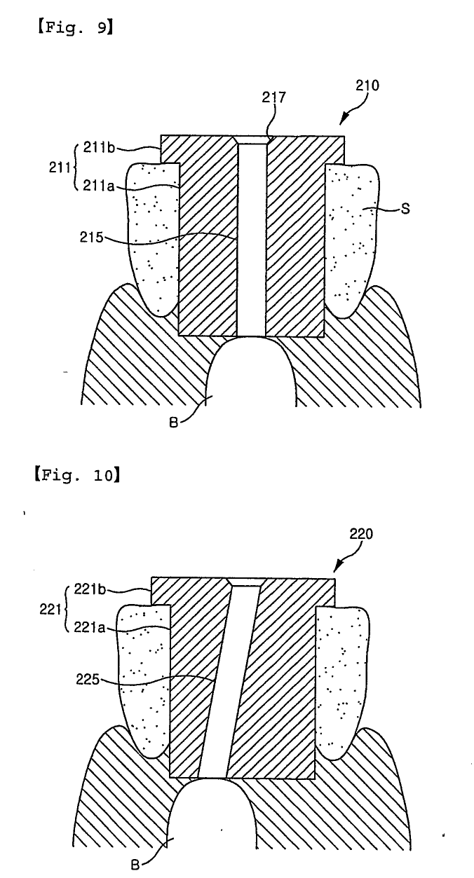

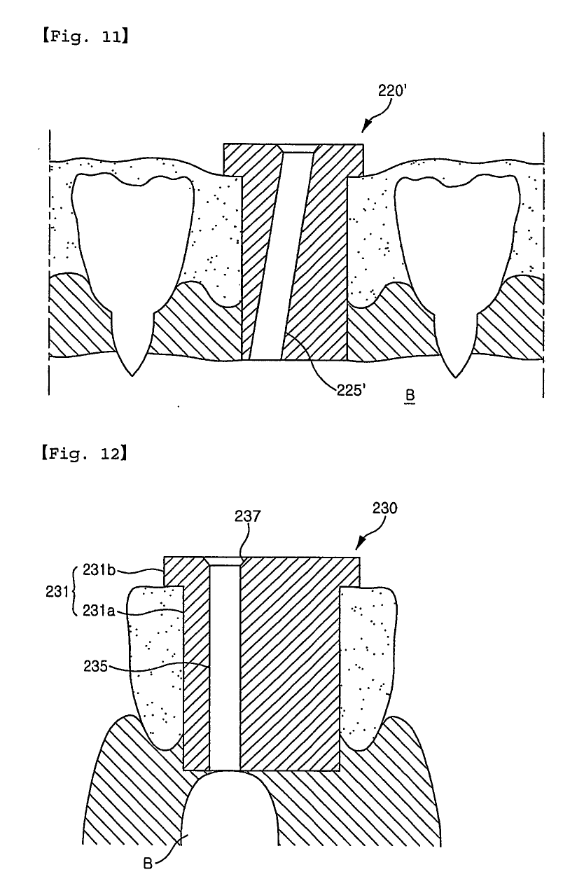

FIG. 8 is a perspective view illustrating a second embodiment of an assistant for implant stent according to the present invention, and FIG. 9 is a side sectional view illustrating a state where the second embodiment of the assistant for implant stent is mounted to the stent.

Referring to the second embodiment illustrated in FIGS. 8 and 9, an assistant for implant stent 210 comprises a body 211 which includes a body portion 211a with a predetermined vertical length and a support portion 211b formed on a top surface of the body portion 211a to have a sectional area greater than the body portion 211a and a predetermined thickness, and a drill insertion hole 215 which is bored from a top surface of the body 211, i.e. a top surface of the support 211b, to a bottom surface of the body 211. Here, a cross section of the body 211 is rectangular with opposite rounded sides but is not limited thereto.

At this time, the drill insertion hole 215 is bored vertically through the body 211 from the top surface of the support body 211b to the bottom surface of the body 211. Further, an upper opening 217 is formed to be narrowed downward such that a drilling means for drilling an alveolar bone B can be easily inserted into the drill insertion hole.

Furthermore, modified examples of this embodiment are more preferable to a patient of which the uppermost end of an alveolar bone B is shifted from the center, rather than the second embodiment of the present invention in which the drill insertion hole 215 is vertically formed at the center of the body 211 as described above. The modified examples of the second embodiment will be described with reference to FIGS. 10 to 13.

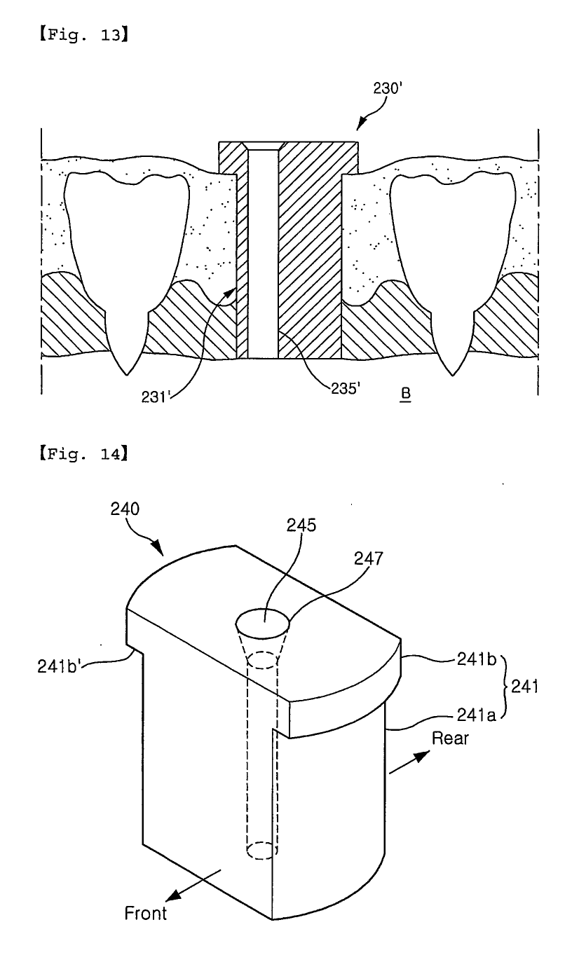

FIG. 10 is a side sectional view illustrating a state where a first modified example of the second embodiment of the assistant for implant stent is mounted to the stent, and FIG. 11 is a front sectional view illustrating a state where another example of the assistant for implant stent in which a drill insertion hole has a different inclination direction from that of the first modified example of the second embodiment is mounted to the stent.

As shown in FIG. 10, the first modified example of an assistant for implant stent 220 according to the second embodiment of the present invention comprises a body 221 including a body portion 221a and a support portion 221b, which take the same shape as those of the assistant for implant stent 210, and a drill insertion hole 225 which is inclined at a predetermined angle laterally with respect to a top surface of the support portion 221b.

Here, if the assistant for implant stent 220 in which the drill insertion hole 225 is inclined at the predetermined angle is used, a drilling operation can be conducted at the most suitable position on the alveolar bone B of even the patient of which the uppermost end of the alveolar bone B is shifted from the center. At this time, the drill insertion hole may be inclined not only in the lateral direction but also in the fore and aft direction as shown in FIG. 11. The direction in which the drill insertion hole 225 or 225′ is inclined is not limited to the lateral or fore and aft direction of the assistant for implant stent 220 or 220′ and may be formed in any directions. Further, the drill insertion hole 225 or 225′ may be formed to have a variety of inclination angles.

Since the uppermost end of the alveolar bone B is generally different for every patient, it is preferred that an operator beforehand prepare a plurality of assistants for implant stent of which inclination directions of the drill insertion holes are different from each other.

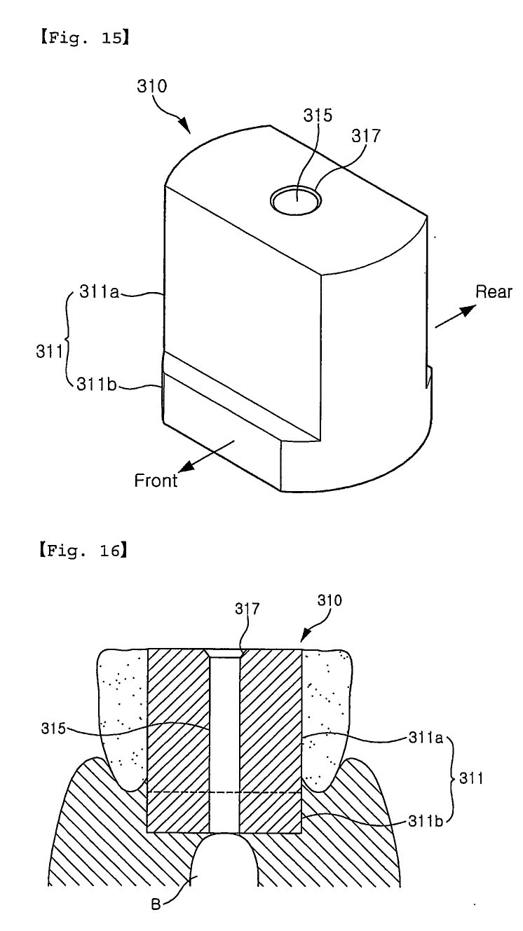

FIG. 12 is a side sectional view illustrating a state where a second modified example of the second embodiment of the assistant for implant stent is mounted to the stent, and FIG. 13 is a front sectional view illustrating a state where another example of the assistant for implant stent in which a drill insertion hole has a different shifting direction from that of the second modified example of the second embodiment is mounted to the stent.

As shown in FIG. 12, the second modified example of an assistant for implant stent 230 according to the second embodiment of the present invention comprises a body 231 including a body portion 231a and a support portion 231b, which take the same shape as those of the assistant for implant stent 210, and a drill insertion hole 235 which is formed to be vertical with respect to a top surface of the support portion 231b and includes an upper opening 237 shifted from the center of the top surface.

Here, if the assistant for implant stent 230 in which the drill insertion hole 235 is shifted by a predetermined distance from the center of the top surface of the body 231 is used, a drilling operation can be conducted at the most suitable position on the alveolar bone B of even the patient of which the uppermost end of the alveolar bone B is shifted from the center. At this time, the drill insertion hole may be shifted not only in the lateral direction but also in the fore and aft direction as shown in FIG. 13. The direction in which the drill insertion hole 235 or 235′ is shifted is not limited to the lateral or fore and aft direction of the assistant for implant stent 230 or 230′ and may be formed in any directions. Further, the drill insertion hole 235 or 235′ may be formed to be inclined in various angles as well as to be vertical with respect to the top surface of the body 231 or 231′.

Since the uppermost end of the alveolar bone B is generally different for every patient, it is preferred that an operator beforehand prepare a plurality of assistants for implant stent of which shifting directions of the drill insertion holes are different from each other.

Furthermore, FIG. 14 shows a third modified example of the assistant for implant stent according to the second embodiment of the present invention. An assistant for implant stent 240 comprises a body 241 which includes a body portion 241a with a predetermined vertical length and a support portion 241b formed on a top surface of the body portion 241a to have a sectional area greater than the body portion 241a and a predetermined thickness, and a drill insertion hole 245 which is bored from a top surface of the body 241, i.e. a top surface of the support 241b, to a bottom surface of the body 241. At this time, the support portion 241b is formed to protrude only in the lateral direction. An upper opening 247 of the drill insertion hole 245 is formed to be narrowed downward such that a drilling means can be easily inserted into the hole. In general, the opening 247 is formed to be narrowed downward to a depth corresponding to the depth of the support portion 241b.

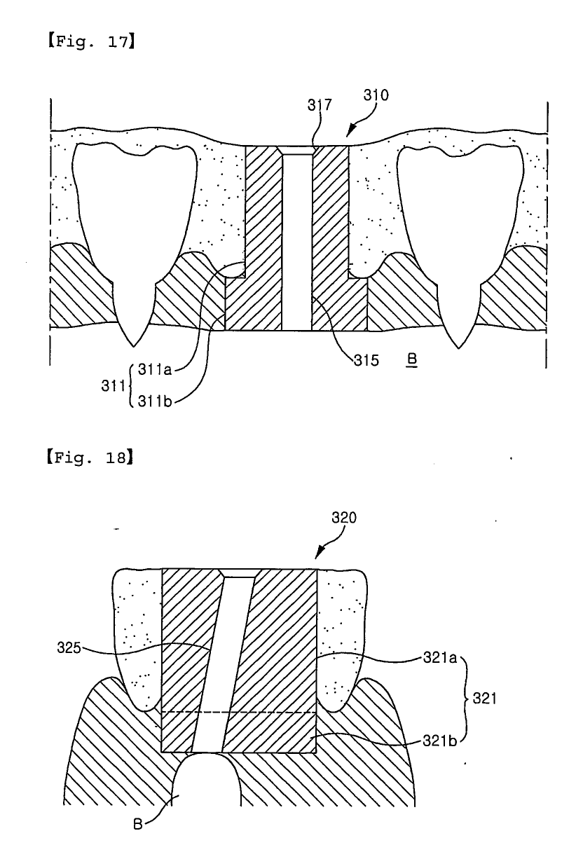

FIG. 15 is a perspective view illustrating a third embodiment of an assistant for implant stent according to the present invention, FIG. 16 is a side sectional view illustrating a state where the third embodiment of the assistant for implant stent is mounted to the stent, and FIG. 17 is a front sectional view illustrating a state where the third embodiment of the assistant for implant stent is mounted to the stent.

As illustrated in the third embodiment of FIGS. 15 to 17, an assistant for implant stent 310 comprises a body 311 which includes a body portion 311a with a predetermined vertical length and a support portion 311b protruding by a predetermined length in the fore and aft direction and formed on a bottom surface of the body portion 311a to have a predetermined thickness, and a drill insertion hole 315 which is bored from a top surface of the body portion 311a to the bottom surface of the support portion 311b. Here, a cross section of the body 311 is rectangular with opposite rounded sides perpendicular to the fore and aft direction but is not limited thereto.

At this time, the drill insertion hole 315 is bored vertically from the center of the top surface of the body 311 to the bottom surface of the body 311, i.e. the bottom surface of the support portion 311b. Further, an upper opening 317 is formed to be narrowed downward such that a drill for drilling an alveolar bone B can be easily inserted into the hole.

Furthermore, modified examples of this embodiment are more preferable to a patient of which the uppermost end of an alveolar bone B is shifted from the center, rather than the third embodiment of the present invention in which the drill insertion hole 315 is vertically formed at the center of the body 311 as described above. The modified examples of the third embodiment will be described with reference to FIGS. 18 to 21.

FIG. 18 is a side sectional view illustrating a state where a first modified example of the assistant for implant stent according to the third embodiment of the present invention is mounted to the stent, and FIG. 19 is a front sectional view illustrating a state where another example of the assistant for implant stent in which a drill insertion hole has a different inclination direction from that of the first modified example of the third embodiment is mounted to the stent.

As shown in FIG. 18, a first modified example of an assistant for implant stent 320 according to the third embodiment of the present invention comprises a body 321 including a body portion 321a and a support portion 321b, which take the same shape as those of the assistant for implant stent 310, and a drill insertion hole 325 which is inclined at a predetermined angle laterally with respect to a top surface of the body 321.

Here, if the assistant for implant stent 320 in which the drill insertion hole 325 is inclined at the predetermined angle is used, a drilling operation can be conducted at the most suitable position on the alveolar bone B of even the patient of which the uppermost end of the alveolar bone B is shifted from the center. At this time, the drill insertion hole may be inclined not only in the lateral direction but also in the fore and aft direction as shown in FIG. 19. The direction in which the drill insertion hole 325 or 325′ is inclined is not limited to the lateral or fore and aft direction of the assistant for implant stent 320 or 320′ and may be formed in any directions. Further, the drill insertion hole 325 or 325′ may be formed to have a variety of inclination angles.

Since the uppermost end of the alveolar bone B is generally different for every patient, it is preferred that an operator beforehand prepare a plurality of assistants for-implant stent of which inclination directions of the drill insertion holes are different from each other.

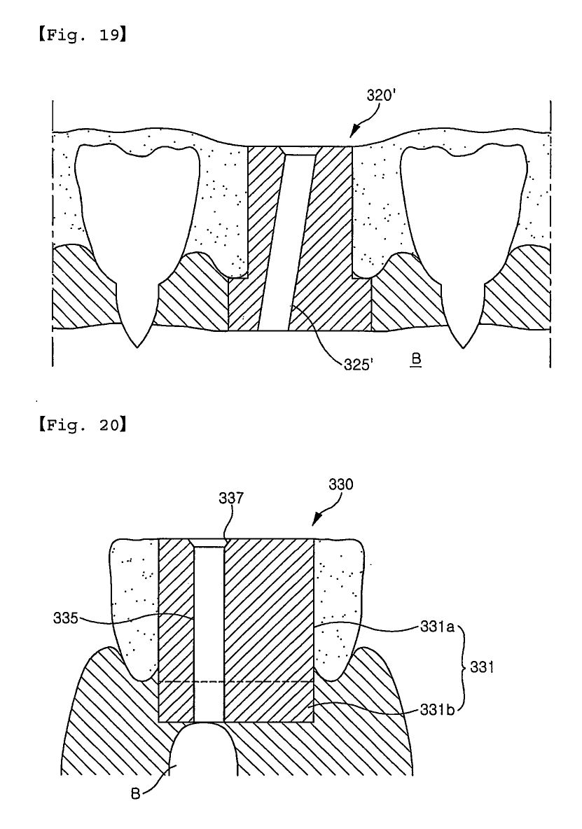

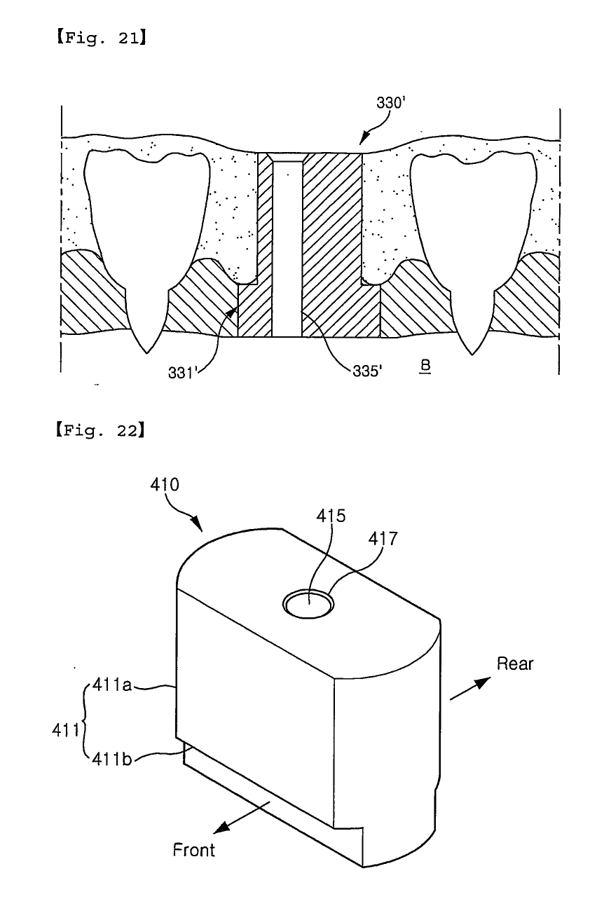

FIG. 20 is a side sectional view illustrating a state where a second modified example the assistant for implant stent according to the third embodiment of the present invention is mounted to the stent, and FIG. 21 is a front sectional view illustrating a state where another example of the assistant for implant stent in which a drill insertion hole has a different shifting direction from that of the second modified example of the third embodiment is mounted to the stent.

As shown in FIG. 20, the second modified example of an assistant for implant stent 330 according to the third embodiment of the present invention comprises a body 331 including a body portion 331a and a support portion 331b, which take the same shape as those of the third embodiment, and a drill insertion hole 335 which is formed to be vertical with respect to a top surface of the body 331 and includes an opening 337 shifted from the center of the top surface.

Here, if the assistant for implant stent 330 in which the drill insertion hole 335 is shifted by a predetermined distance from the center of the top surface of the body 331 is used, a drilling operation can be conducted at the most suitable position on the alveolar bone B of even the patient of which the uppermost end of the alveolar bone B is shifted from the center. At this time, the drill insertion hole may be shifted not only in the lateral direction but also in the fore and aft direction as shown in FIG. 21. The direction in which the drill insertion hole 335 or 335′ is shifted is not limited to the lateral or fore and aft direction of the assistant for implant stent 330 or 330′ and may be formed in any directions. Further, the drill insertion hole 335 or 335′ may be formed to be inclined in various angles as well as to be vertical with respect to the top surface of the body 331 or 331′.

Since the uppermost end of the alveolar bone B is generally different for every patient, it is preferred that an operator beforehand prepare a plurality of assistants for implant stent of which shifting directions of the drill insertion holes are different from each other.

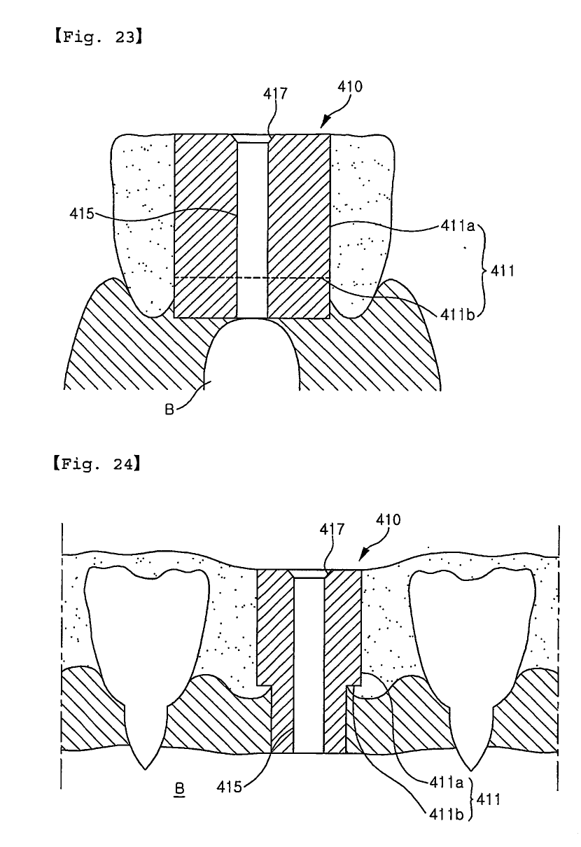

FIG. 22 is a perspective view illustrating a fourth embodiment of an assistant for implant stent according to the present invention, FIG. 23 is a side sectional view illustrating a state where the fourth embodiment of the assistant for implant stent is mounted to the stent, and FIG. 24 is a front sectional view illustrating a state where the fourth embodiment of the assistant for implant stent is mounted to the stent.

As shown in these figures, an assistant for implant stent 410 comprises a body 411 which includes a body portion 411a with a predetermined vertical length and stepped portions 411b stepped inward from the opposite front and rear lower edges of the body portion 411a, and a drill insertion hole 415 which is bored through the body 411. Here, a cross section of the body 411 is rectangular with the opposite sides being rounded but is not limited thereto.

At this time, the drill insertion hole 415 is bored vertically from the center of the top surface of the body 411 to a bottom surface of the body 411. Further, an upper opening 417 is formed to be narrowed downward such that a drill for drilling an alveolar bone B can be easily inserted into the hole.

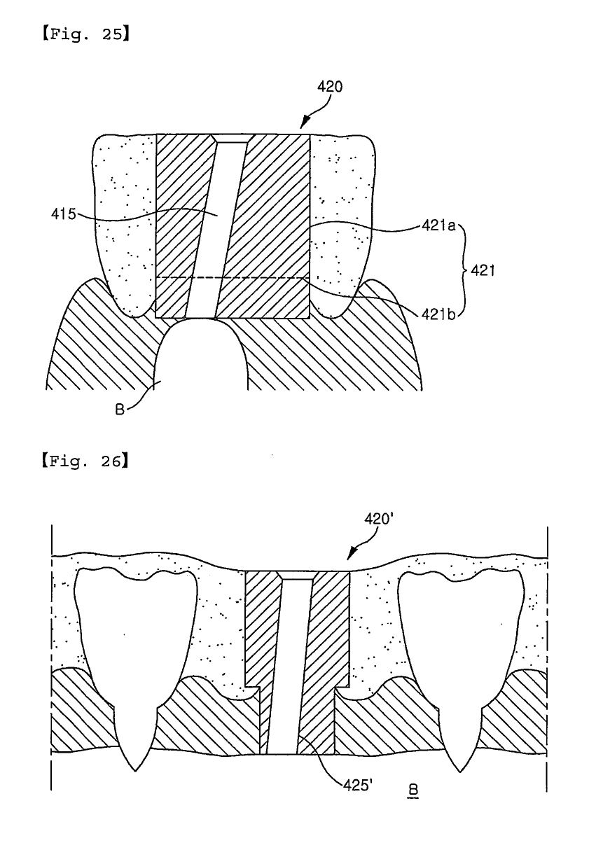

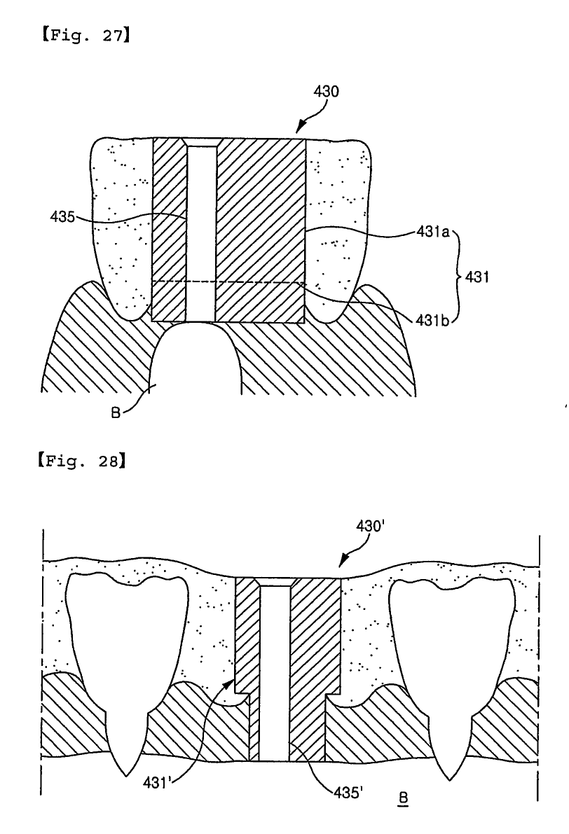

Furthermore, modified examples of this embodiment are more preferable to a patient of which the uppermost end of an alveolar bone B is shifted from the center, rather than the fourth embodiment of the present invention in which the drill insertion hole 415 is vertically formed at the center of the body 411 as described above. The modified examples of the third embodiment will be described with reference to FIGS. 25 to 28.

FIG. 25 is a side sectional view illustrating a state where a first modified example of the assistant for implant stent according to the fourth embodiment of the present invention is mounted to the stent, and FIG. 26 is a front sectional view illustrating a state where another example of the assistant for implant stent in which a drill insertion hole has a different inclination direction from that of the first modified example of the fourth embodiment is mounted to the stent.

As shown in FIG. 25, the first modified example of an assistant for implant stent 420 according to the fourth embodiment of the present invention comprises a body 421 including a body portion 421a and a stepped portion 421b, which take the same shape as those of the assistant for implant stent 410, and a drill insertion hole 425 which is inclined at a predetermined angle laterally with respect to a top surface of the body 421.

Here, if the assistant for implant stent 420 in which the drill insertion hole 425 is inclined at the predetermined angle is used, a drilling operation can be conducted at the most suitable position on the alveolar bone B of even the patient of which the uppermost end of the alveolar bone B is shifted from the center. At this time, the drill insertion hole may be inclined not only in the lateral direction but also in the fore and aft direction as shown in FIG. 26. The direction in which the drill insertion hole 425 or 425′ is inclined is not limited to the lateral or fore and aft direction of the assistant for implant stent 420 or 420′ and may be formed in any directions. Further, the drill insertion hole 425 or 425′ may be formed to have a variety of inclination angles.

Since the uppermost end of the alveolar bone B is generally different for every patient, it is preferred that an operator beforehand prepare a plurality of assistants for implant stent of which inclination directions of the drill insertion holes are different from each other.

FIG. 27 is a side sectional view illustrating a state where a second modified example of the assistant for implant stent according to the fourth embodiment of the present invention is mounted to the stent, and FIG. 28 is a front sectional view illustrating a state where another example of the assistant for implant stent in which a drill insertion hole has a different shifting direction from that of the second modified example of the fourth embodiment is mounted to the stent.

As shown in FIG. 27, the second modified example of an assistant for implant stent 430 according to the fourth embodiment of the present invention comprises a body 431 including a body portion 431a and a stepped portion 431b, which take the same shape as those of the assistant for implant stent 410, and a drill insertion hole 435 which is formed to be vertical with respect to a top surface of the body 431 and includes an opening 437 shifted by a predetermined distance from the center of the top surface.

Here, if the assistant for implant stent 430 in which the drill insertion hole 435 is shifted by the predetermined distance from the center of the top surface of the body 431 is used, a drilling operation can be conducted at the most suitable position on the alveolar bone B of even the patient of which the uppermost end of the alveolar bone B is shifted from the center. At this time, the drill insertion hole may be shifted not only in the lateral direction but also in the fore and aft direction as shown in FIG. 28. The direction in which the drill insertion hole 435 or 435′ is shifted is not limited to the lateral or fore and aft direction of the assistant for implant stent 430 or 430′ and may be formed in any directions. Further, the drill insertion hole 435 or 435′ may be formed to be inclined in various angles as well as to be vertical with respect to the top surface of the body 431 or 431′.

Since the uppermost end of the alveolar bone B is generally different for every patient, it is preferred that an operator beforehand prepare a plurality of assistants for implant stent of which shifting directions of the drill insertion holes are different from each other.

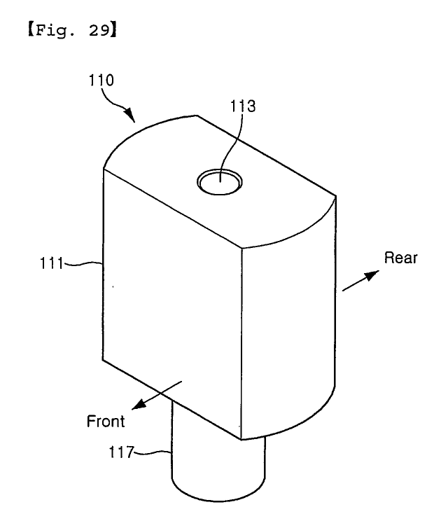

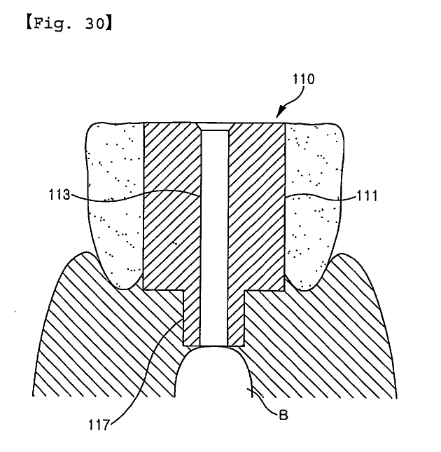

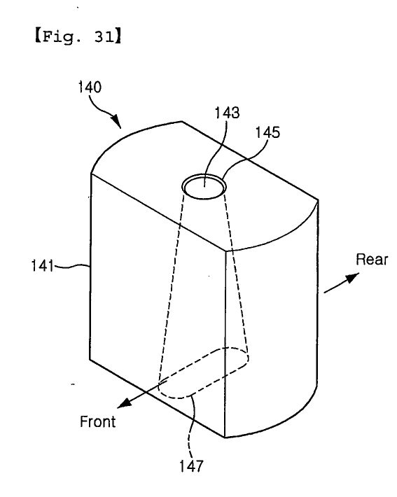

FIG. 29 is a perspective view illustrating a state where an extended portion is further formed in the assistant for implant stent according to the present invention, and FIG. 30 is a sectional view of the assistant for implant stent shown in FIG. 29.

As shown in FIGS. 29 and 30, the assistant for implant stent 110 further comprises an extended portion 117 which has a sectional area less than the body 111 and protrudes downward by a predetermined length form the bottom surface of the body 111. At this time, the drill insertion hole 113 is formed to pass through the extended portion 117. Here, the assistant for implant stent 110 shown in FIGS. 29 and 30 is merely described with reference to the first embodiment, but it may be applied to all the other embodiments and modified examples thereof.

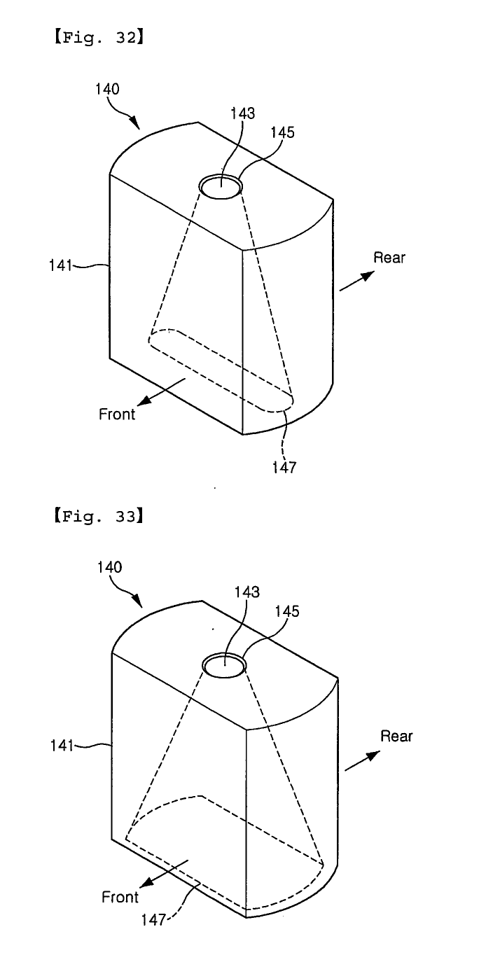

FIGS. 31 to 37 are perspective views of the assistant for implant stent with a variety of drill insertion holes formed therein according to the present invention.

As shown in FIGS. 31 to 33, upper and lower openings 145 and 147 of the drill insertion hole of the assistant for implant stent 140 are formed to be different from each other. The upper opening 145 of the drill insertion hole 143 is formed to be circular, but the drill insertion hole is expanded as it goes downward. Therefore, the lower opening 147 is formed to extend in a fore and aft or lateral direction or in both the fore and aft direction and the lateral direction.

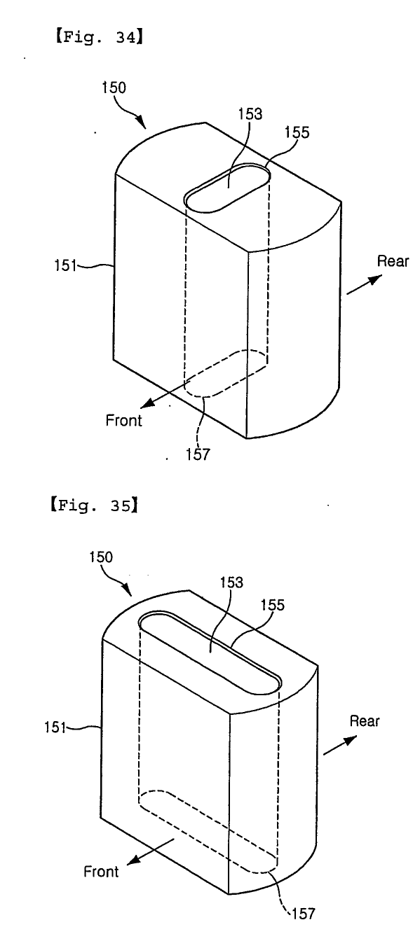

Further, a drill insertion hole 153 of the assistant for implant stent 150 shown in FIG. 34 or 35 is formed in such manner that its upper and lower openings have the same shape as each other and are elongated in a fore and aft or lateral direction of a body 151.

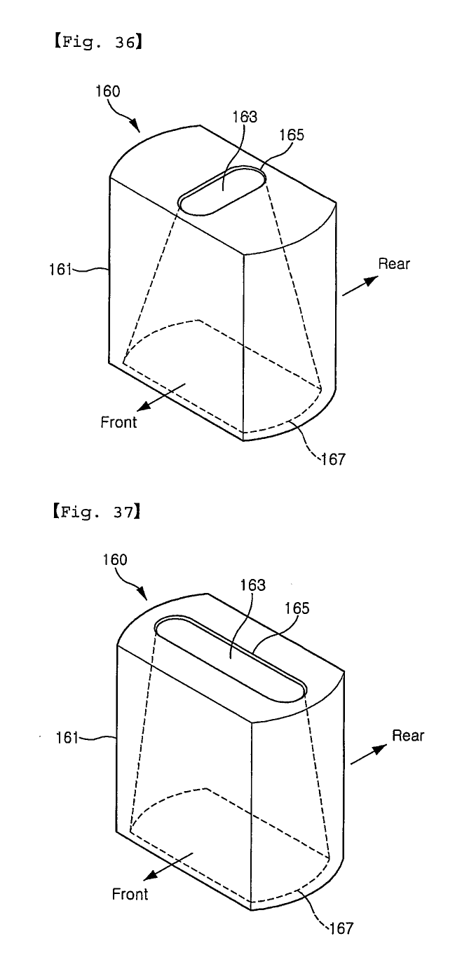

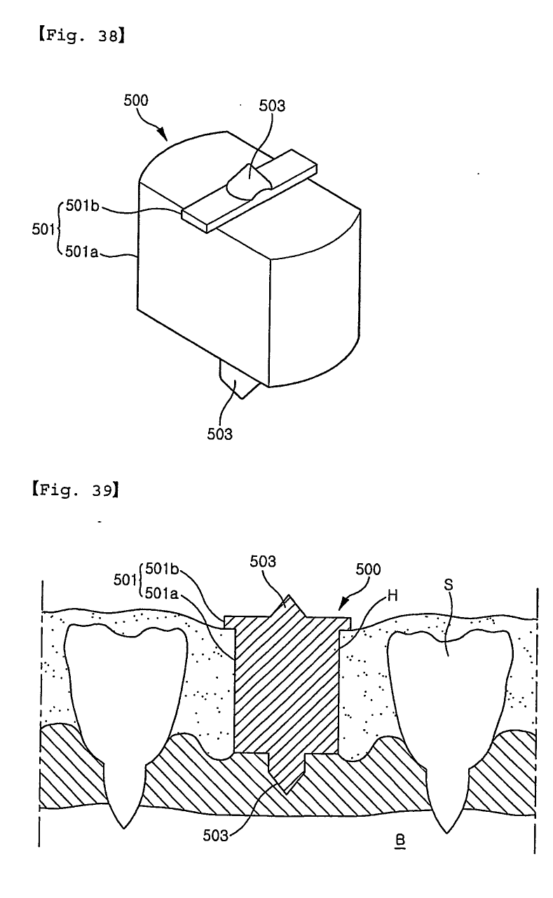

In the meantime, referring to FIGS. 36 and 37, a drill insertion hole 163 of the assistant for implant stent 160 shown in the figures is formed in such a manner that its upper and lower openings 165 and 167 have different shapes from each other. That is, the upper opening 165 is formed to extend in a fore and aft or lateral direction of a body 161 as shown in FIG. 34 or 35, whereas the lower opening 167 is formed to extend in both the fore and aft direction and the lateral direction as shown in FIG. 34.

As described above, the reason that the drill insertion hole can be formed to have various shapes is that a drilling angle of the drilling means can be changed when the alveolar bone is drilled. Although the variety of drill insertion holes illustrated in FIGS. 31 to 37 are applied to the assistant for implant stent according to the first embodiment of the present invention, it is apparent that they can be applied to the other embodiments and the modified examples thereof.

FIG. 38 is a perspective view illustrating an X-ray imaging assistant according to the present invention, and FIG. 39 is a front sectional view illustrating a state where the X-ray imaging assistant is mounted to the stent.

The X-ray imaging assistant 500 comprises a body 501 which includes a body portion 501a with a predetermined vertical length and a support portion 501b protruding on a top surface of the body portion 501a in both opposite directions, and a direction indicating means 503 formed to protrude from the top and bottom surfaces of the body 501.

The X-ray imaging assistant 500 so configured is used to find out an optimum angle at which the alveolar bone B should be drilled. A process of drilling the alveolar bone is as follows. First, a predetermined hole H is formed in the stent S such that the X-ray imaging assistant 500 can be inserted therein. After the hole H has been completed, the X-ray imaging assistant 500 is inserted in the hole H and X-ray imaging is then performed in such a state. Thereafter, if an imaged film is developed, the X-ray imaging assistant 500 is shown together with the alveolar bone B on the film. Therefore, the operator can know the optimum drilling angle by comparing the alveolar bone B with an imaginary axis connecting end points of the direction indicating means 503.

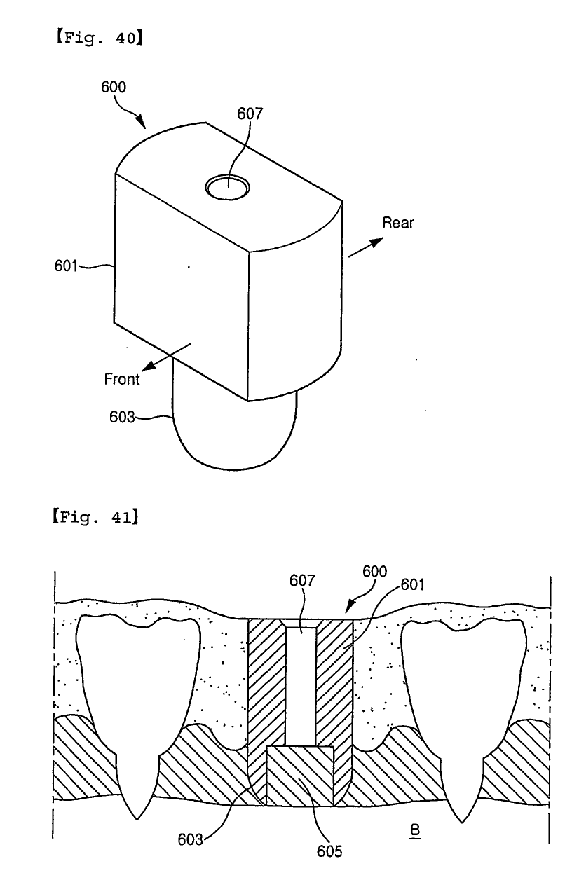

FIG. 40 is a perspective view of a gingiva removal assistant according to the present invention, and FIG. 41 is a front sectional view illustrating a state where the gingiva removal assistant is mounted to the stent.

A gingiva removal assistant 600 comprises a body 601 with a predetermined length and a cutter 603 formed on a bottom of the body 601.

The body 601 takes the shape of a rectangular horizontal section with opposite rounded sides and has a predetermined vertical length. The cutter 603 takes the shape of a hollow cylinder of which outer diameter is reduced in a downward direction, such that the gingiva G can be incised, and also has a predetermined internal space into which the incised gingiva G can be inserted. Further, a through-hole 607 that is bored through the body 601 and the cutter 603 is provided at the gingiva removal assistant 600 in order to check errors between an actual drilling position on the alveolar bone and an estimated position on the dental cast, so that the operator can decide whether the region on the alveolar bone to be drilled is acceptable or suitable through the through-hole 607.

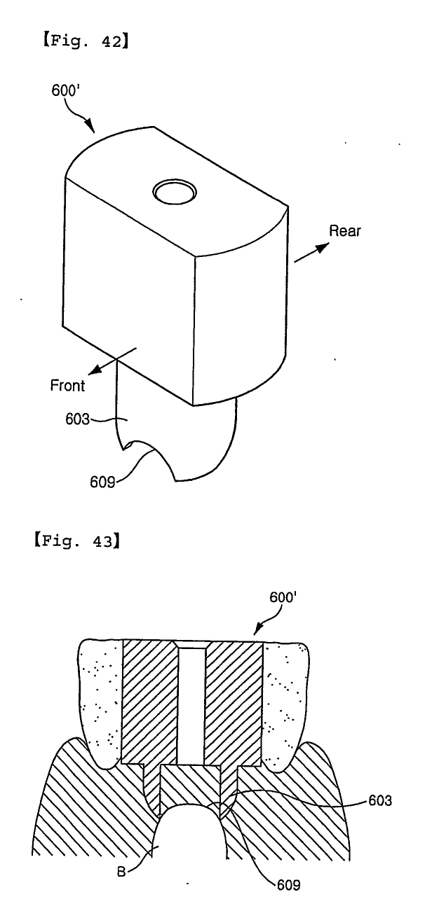

FIG. 42 is a perspective view illustrating another embodiment of a gingiva removal assistant according to the present invention, and FIG. 43 is a side sectional view illustrating a state where the gingiva removal assistant shown in FIG. 42 is mounted to the stent.

This embodiment of the gingiva removal assistant according to the present invention is formed to have the same shape as shown in FIGS. 40 and 41, except that a recess 609 corresponding to the shape of an upper portion of the general alveolar bone B is provided at a lower end of the cutter 603 such that an upper portion of the alveolar bone B can be inserted therein. Since a gingiva removal assistant 600′ with the aforementioned recess 609 formed therein has a large contact area between the cutter 603 and the alveolar bone B, the gingiva G can be more clearly removed.

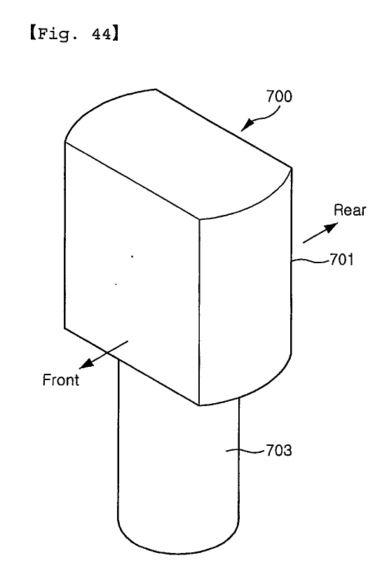

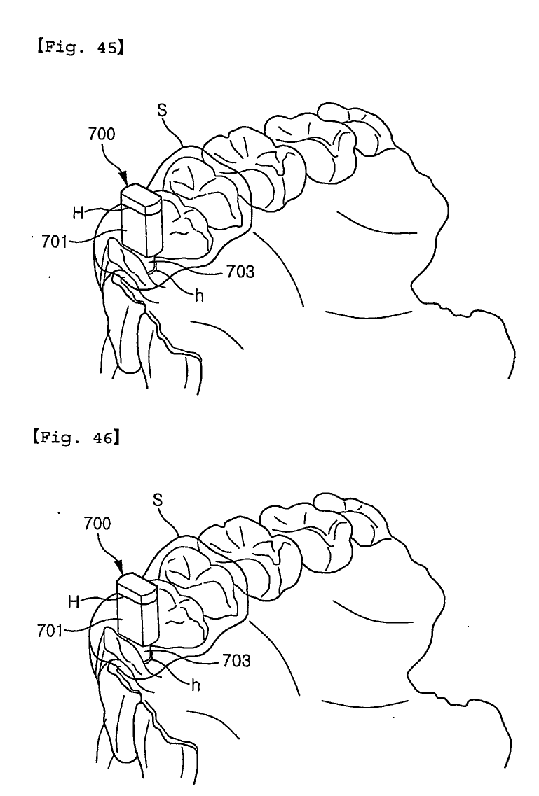

FIG. 44 is a perspective view of a stent forming assistant according to the present invention, and FIG. 45 is a perspective view illustrating a state where the stent forming assistant is used.

When machining a stent hole H through which the assistant for implant stent, the X-ray imaging assistant and the gingiva removal assistant are inserted in the stent, it is impossible to perform the drilling operation if the horizontal section of the body is not circular.

Therefore, other methods are required for machining the stent hole H. That is, the stent hole H can be simply machined by using the stent forming assistant 700 as shown in FIG. 44.

The stent forming assistant 700 comprises a forming portion 701 having the same horizontal section as the aforementioned body of the assistant for implant stent, the X-ray imaging assistant or the gingiva removal assistant, and a cylindrical insert portion 703 extending downward from a bottom surface of the forming portion 701. At this time, the body of the assistant for implant stent, the X-ray imaging assistant or the gingiva removal assistant has the constant horizontal section area over all the aforementioned embodiments.

A process of manufacturing the stent hole H will be discussed with reference to FIG. 44. The stent S is manufactured in such a manner that the insertion recess h is formed in an optimum direction at a region on the alveolar bone among the plaster cast of the oral cavity, the insert portion 703 of the stent forming assistant 700 is inserted in the insertion recess h, and the stent forming assistant 700 is placed in a proper direction. Thereafter, if the stent forming assistant 700 is removed, the stent hole H through which various kinds of the assistant for implant stent, the X-ray imaging assistant and the gingiva removal assistant are inserted in the stent is completed.

FIG. 46 is a perspective view of a guide for the assistant according to the present invention, and FIG. 47 is a front sectional view illustrating a state where the guide for the assistant is mounted to the stent.

A guide for the assistant 800 allows various kinds of the assistant for implant stent, the X-ray imaging assistant and the gingiva removal assistant to be easily inserted in the stent hole H by reducing friction force with the stent hole H. Referring to the figures, the guide 800 for the assistant comprises a body 801 with a predetermined length and an insertion hole 803 with upper and lower openings formed in a vertical direction. The body 801 is formed to be attachable to an inner wall surface of the stent hole H, and the insertion hole 803 is formed in such a manner that various kinds of the assistant for implant stent, the X-ray imaging assistant and the gingiva removal assistant can be fitted and accommodated in the insertion hole.

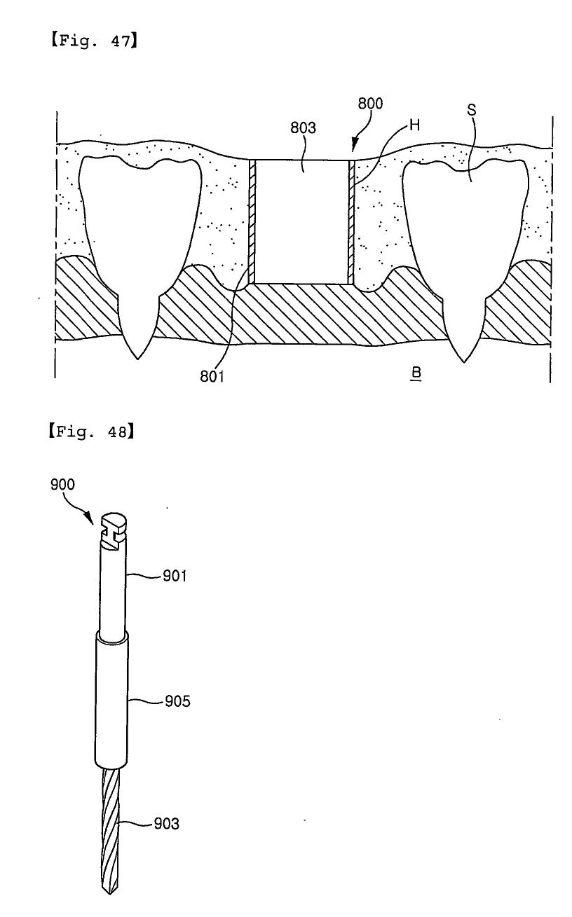

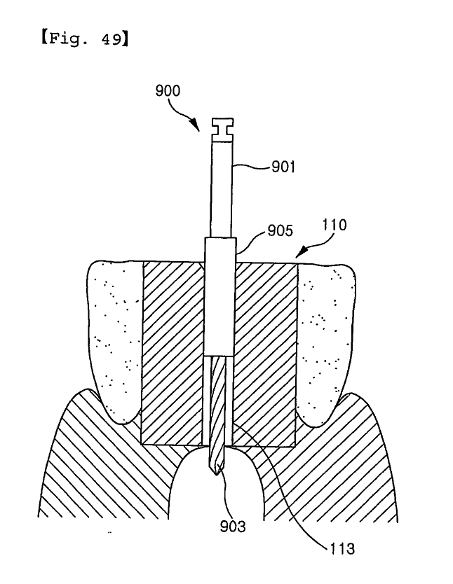

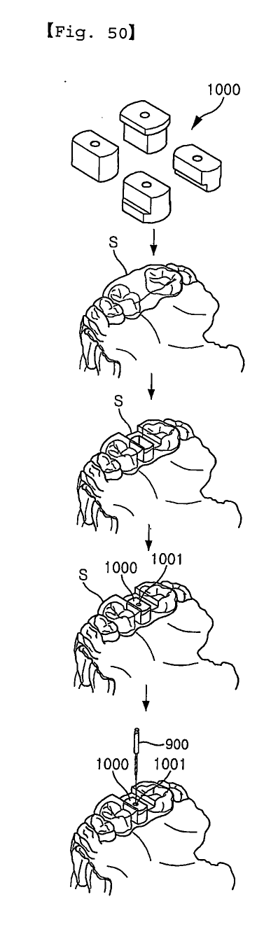

FIG. 48 is a perspective view of a drilling tool for drilling an alveolar bone according to the present invention, and FIG. 49 is a side sectional view illustrating a state where the drilling tool is inserted in the first embodiment of the assistant for implant stent according to the present invention.

Referring to the figures, a drilling tool 900 is configured in such a manner that a connecting member 901 capable of being coupled with an external power transmission unit is formed at an upper portion of the drilling tool, a drilling member 903 for drilling the alveolar bone is formed at a lower portion thereof, and a cylindrical guide member 905 with the diameter greater than that of the drilling member 903 is formed between the connecting member 901 and the drilling member 903. The connecting member 901, the drilling member 903 and the cylindrical guide member 905 are integrally formed with one another.

Here, since the guide member 905 is inserted through the drill insertion hole 113 of the assistant for implant stent 110 shown in FIGS. 2 and 3 to drill the alveolar bone, the guide member should be formed to have at least the same diameter as the drill insertion hole 113. Further, since the guide member 905 is formed to have the diameter greater than that of the drilling member 903, the guide member functions as a stopper for allowing the drilling member 903 not to be further introduced beyond a predetermined depth when performing the drilling operation for the alveolar bone. Since it is difficult for the operator to visually determine the scales formed on the rotating drilling tool 900 due to the facts that a region where an implant will be placed is generally narrow and deep and the profuse bleeding occurs during the operation, the stopper should be formed as such.

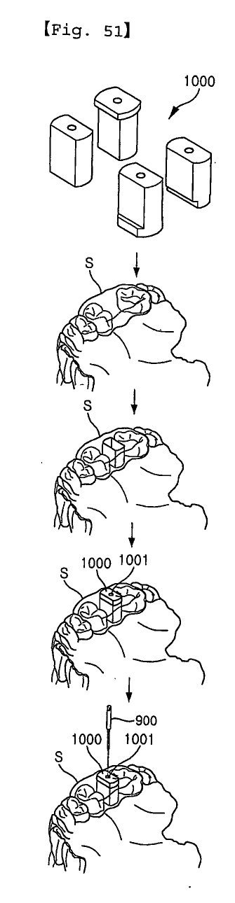

FIG. 50 is a schematic view illustrating a process of drilling the alveolar bone with the assistant for implant stent according to the present invention.

A process of drilling the alveolar bone with the assistant for implant stent according to the present invention comprises the steps of preparing an assistant for stent 1000, manufacturing a stent S, cutting a portion on a top surface of the stent S to prepare a place for mounting the assistant for stent 1000 to the stent S, and mounting the assistant for stent 1000 to the stent S, and drilling the alveolar bone by inserting the drilling tool 900 shown in FIGS. 48 and 49 through the drill insertion hole 1001 of the assistant for stent 1000. At this time, the assistant for stent 1000 should be selected and used such that a top surface of the assistant for stent 1000 is level with or lower than the top surface of the stent S where a portion thereof is cut away.

Any assistant for stent other than the assistants for stent according to the present invention may be employed as the assistant for stent 1000 for use in the process of drilling the alveolar bone as shown in FIG. 50.

Here, the assistant for stent 1000 according to the each embodiment of the present invention should be mounted to the cut-away portion on the top surface of the stent S, when it is impossible to drill the alveolar bone even with a conventional assistant for stent in a case where it is not easy to insert the drilling tool 900 shown in FIGS. 48 and 49 due to the small degree of opening the mouth of the patient or a deep drilling operation is required when drilling the alveolar bone.

FIG. 51 is a schematic view illustrating another process of drilling the alveolar bone using the assistant for implant stent according to the present invention.

Another process of drilling the alveolar bone with the assistant for implant stent according to the present invention comprises the steps of preparing an assistant for stent 1000, manufacturing a stent S, preparing a place for mounting the assistant for stent 1000 to the stent S, and mounting the assistant for stent 1000 to the stent S, and drilling the alveolar bone by inserting the drilling tool 900 shown in FIGS. 48 and 49 through the drill insertion hole 1001 formed on the assistant for stent 1000. At this time, the assistant for stent 1000 should be selected to be level with the stent S. Alternatively, the assistant for stent may be selected to protrude at a certain height from the top surface of the stent S. The reason is that it is impossible to drill the alveolar bone even with a short assistant for stent in a case where the drilling tool 900 cannot be supported due to the short length of the drill insertion hole when drilling the alveolar bone. That is, the reason is that the drilling operation can be conducted only if a portion of the guide member 905 of the drilling tool 900 is inserted in the drill insertion hole 1001 at a predetermined length thereof

Although the configuration of the assistant for implant stent and the method of drilling the alveolar bone using the assistant for implant stent according to the preferred embodiments of the present invention described above have been explained in connection with the above descriptions and the accompanying drawings, they are mere examples of the present invention. It will be apparent to those skilled in the art that various modifications and changes may be made thereto without departing from the scope and spirit of the invention.

### INDUSTRIAL APPLICABILITY

The assistant for implant stent of the present invention so configured has the following advantages:

First, since the drill is inserted in the assistant for implant stent according to the predetermined drilling angle for the alveolar bone, the operator does not have to pay attention to a change in the drilling angle during the operation. Therefore, the operation time is reduced and the operation is easily conducted, thereby reducing a degree of fatigue of the operator. Further, even though the drilling angle is changed during the operation due to the mismatch of the position of an alveolar bone with the drilling angle expected out of the oral cavity, the position of the center of an occlusal plane cannot be changed, and thus, an ideal final prosthesis can be manufactured and invented. Moreover, since the changed angle can be measured in a numerical method, a scientific and mechanical operation can be performed.

Second, since the drill is guided by the assistant for implant stent, the vibration of drill can be prevented upon the drilling, whereby the alveolar bone can be accurately and stably drilled.

Third, since the drilling angle expected and determined out of the oral cavity can be reconstructed in the actual operation in the oral cavity, the results after the operation can be predicted at a certain degree before the operation. Similar to the actual operation process, several implants on the dental cast are perfectly aligned out of the oral cavity in the fore and aft direction and the lateral direction by using a surveyor. Further, even though it is in a state where the gingiva is not incised, more mechanical results can be pursued by performing a trial drilling on an optimum position on the dental cast and applying the obtained drilling angle to the assistant for implant stent. In fact, there is almost no case where the angle in the fore and aft direction is changed during the operation using the assistant for implant stent, and only the angle in the lateral direction is changed according to the position of the alveolar bone. Further, by putting the stent mounted with the X-ray imaging assistant into the oral cavity of a patient and conducting the X-ray imaging, the length of the placed implant can be predicted, and the acceptability of the direction of the drill insertion hole and relationship between surrounding major components can also be estimated. Further, the insertion direction may also beforehand be modified, if desired. Furthermore, by putting the X-ray imaging assistant into the oral cavity of the patient and having a CT scan taken, a direction in which the alveolar bone should be drilled can be predicted.

Fourth, since the drill scale corresponding to a length obtained by adding the length of the assistant for implant stent to the drilling depth expected when the assistant for implant stent is brought into contact with the alveolar bone is positioned on the uppermost portion of the assistant for implant stent, the drilling operation can be conducted without the obscure sight due to the bleeding during the conventional operation can be removed, thereby enhancing the operation stability. Further, by using a drilling tool with a stopper function, the operation stability can be enhanced without any danger to the excessive drilling.

Fifth, since the body of the assistant for implant stent is standardized and thus other assistant for implant stent can also be employed if necessary, the operation conditions can be effectively satisfied.

Sixth, the X-ray imaging assistant can be used as a tool for correcting magnification power when the X-ray imaging is taken.

Seventh, if a special circumstance where the assistant for implant stent cannot be used during the operation is produced, the operation can be conducted with a conventional method by removing the assistant for implant stent and using only the guide for the assistant.

1. An assistant for implant stent for placing an implant in an alveolar bone of a patient, comprising:
a body with a predetermined length and a drill insertion hole bored through the body from a top surface to a bottom surface thereof,
wherein the body comprises a support portion with a predetermined thickness and a sectional area greater than that of the body, said the support portion being formed on the top surface of the body.

2. An assistant for implant stent for placing an implant in an alveolar bone of a patient, comprising:
a body with a predetermined length and a drill insertion hole bored through the body from a top surface to a bottom surface thereof,
wherein the body includes a support portion with a predetermined thickness, said support portion being formed on the bottom surface of the body and protruding in opposite directions by a predetermined length.

3. An assistant for implant stent for placing an implant in an alveolar bone of a patient, comprising:
a body with a predetermined length and a drill insertion hole bored through the body from a top surface to a bottom surface thereof,
wherein the body includes stepped portion recessed on opposite lower edges of the body.

4. An assistant for implant stent for placing an implant in an alveolar bone of a patient, comprising:
a body with a predetermined length and a drill insertion hole bored through the body from a top surface to a bottom surface thereof,
wherein an opening of the drill insertion hole formed on the top surface of the body is shifted from the center on the top surface of the body by a predetermined distance.

5. The assistant as claimed in claim 1, wherein an opening of the drill insertion hole formed on the top surface of the body is shifted from the center on the top surface of the body by a predetermined distance.

6. The assistant as claimed in claim 1, wherein the drill insertion hole is formed to be inclined at a predetermined angle.

7. The assistant as claimed in claim 5, wherein the drill insertion hole is formed to be inclined at a predetermined angle.

8. The assistant as claimed in claim 1, wherein an extended portion is formed on the bottom surface of the body to protrude downward, and the drill insertion hole is bored through the extended portion.

9. The assistant as claimed in claim 5, wherein an extended portion is formed on the bottom surface of the body to protrude downward, and the drill insertion hole is bored through the extended portion.

10. The assistant as claimed in claim 1, wherein a horizontal sectional area of the drill insertion hole increases downward of the body.

11. The assistant as claimed in claim 1, wherein the upper opening of the drill insertion hole is narrowed downward.

12. The assistant as claimed in claim 1, wherein a horizontal section of the body is rectangular with opposite rounded sides, circulars, or rectangular with rounded corners.

13. The assistant as claimed in claim 1, wherein a horizontal section of the upper opening is rectangular with opposite rounded sides, circular, or rectangular with rounded corners.

14. An X-ray imaging assistant for determining a direction in which an implant is placed in an alveolar bone of a patient, comprising:
a body with a predetermined length, and
a direction indication means formed to protrude from top and bottom surfaces of the body.

15. The assistant as claimed in claim 14, wherein a support portion is further provided on the top surface of the body.

16. An assistant for removing gingiva to place an implant in an alveolar bone of a patient, comprising:
a body with a predetermined length, and
a cutter taking the shape of a hollow tube and protruding from the bottom surface of the body.

17. The assistant as claimed in claim 16, further comprising a through-hole bored through the body from the top surface to the bottom surface of the body.

18. The assistant as claimed in claim 16, wherein a recess into which an upper portion of the alveolar bone is inserted is formed at a lower portion of the cutter.

19. A guide for an assistant for guiding an assistant for implant stent for placing an implant in an alveolar bone of a patient, wherein the guide is shaped as a hollow tube in which the assistant for implant stent is inserted and accommodated.

20. An assistant for stent forming for preparing a mounting position of an assistant for implant stent for placing an implant in an alveolar bone of a patient, comprising:
a forming portion with a predetermined length and an insert portion formed to protrude from a bottom surface of the forming portion.

21. A drilling tool for drilling an alveolar bone of a patient, comprising:
a connecting member for allowing the tool to be coupled with a power transmission unit, said connecting member being formed on an upper portion of the tool;
a drilling member for drilling the alveolar bone, said drilling member being formed at a lower portion of the tool; and
a cylindrical guide member with a diameter greater than that of the drilling member, said guide member being formed between the connecting member and the drilling member.
